(19) United States
(12) Patent Application Publication
(10) Pub. No.: US 2008/0292278 A1
(43) Pub. Date: Nov. 27, 2008

(54) Video/Audio Recording/Reproducing Device

(75) Inventors: Hiroshi Imanishi, Osaka (JP); Yuji Tanikawa, Osaka (JP); Takashi Akiyama, Osaka (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., Osaka (JP)

(21) Appl. No.: 11/667,771

(22) PCT Filed: Apr. 24, 2006
(86) PCT No.: PCT/JP2006/308581

§ 371 Date: May 15, 2007

(30) Foreign Application Priority Data
Jul. 8, 2005 (JP) 2005-199637

(51) Int. Cl. H04N 7/26

(52) U.S. Cl. 386/124; 386/E05.001

(57) ABSTRACT

To achieve simultaneous recording of a plurality of programs, first and second system LSIs (10, 20) both having compression and decompression functions for video/audio information are connected to each other via a data bus (30). To attain synchronization of real-time display and chasing playback display of a program under recording, a hard disk drive (33) is connected to one of the system LSIs. A sync signal in a video/audio input of the first system LSI is supplied to the second system LSI, and a video/audio output of the second system LSI is supplied to the first system LSI as another video/audio input.

### TECHNICAL FIELD

The present invention relates to a video/audio recording/playback apparatus permitting simultaneous recording of a plurality of programs.

### BACKGROUND ART

In recording of video/audio information of a received broadcast program into a disk medium, the video/audio information is generally compressed with an encoder. In playback thereof, a decoder is operated to decompress the information.

In some conventional technology, to ensure execution of normal recording/playback operation even during dubbing from a hard disk to a DVD (digital versatile disk), a second decoder and a second encoder are provided for dubbing, in addition to a first encoder for recording and a first decoder for playback. If no dubbing is made, the first and second encoders can be operated in parallel to attain two-program simultaneous recording. Moreover, with further use of the first decoder, another program can be played back while two-program simultaneous recording is underway (see Patent Literature 1).

### Patent Literature 1: Japanese Laid-Open Patent Publication No. 2003-224813 DISCLOSURE OF THE INVENTION

### Problems to be Solved by the Invention

The conventional technology described above lacks in extensibility to simultaneous recording of three or more programs. It also has a problem of causing disturbance in video/audio output at the time of switching between real-time display and chasing playback display of a program under recording.

An object of the present invention is providing a video/audio recording/playback apparatus capable of easily increasing the number of programs that can be recorded simultaneously and also easily attaining synchronization between real-time display and chasing playback display of a program under recording.

### Means for Solving the Problems

To attain the above object, according to the present invention, a plurality of LSIs each having a video/audio processing section are connected to each other, thereby to achieve simultaneous recording of a plurality of programs and also attain synchronization between an input of one LSI and an output of another LSI.

To state specifically, the video/audio recording/playback apparatus of the present invention is a video/audio recording/playback apparatus permitting simultaneous recording of a plurality of programs, including: a plurality of LSIs each having a function of performing compression processing for a video/audio input, a function of performing decompression processing for video/audio data, and a function of executing data transfer therebetween; a disk drive connected to any of the plurality of LSIs; and synchronization means for synchronizing a video/audio output of a second LSI among the plurality of LSIs with a video/audio input of a first LSI among the plurality of LSIs, the second LSI obtaining the video/audio output based on video/audio data already recorded in the disk drive while the first LSI being recording video/audio data obtained by performing compression processing for the video/audio input into the disk drive.

### EFFECT OF THE INVENTION

According to the present invention, the number of programs that can be recorded simultaneously can be easily increased, and also synchronization between real-time display and chasing playback display of a program under recording can be easily attained.

### BRIEF DESCRIPTION OF THE DRAWINGS

FIG. 1 is a block diagram of a video/audio recording/playback apparatus of the present invention.

FIG. 2 is a block diagram showing an internal detailed configuration of one system LSI in FIG. 1.

### DESCRIPTION OF REFERENCE NUMERALS

10, 20 System LSI
11, 21 Video/audio processing section
12, 22 Optical disk control section
13, 23 Memory control section
14, 24 Data transfer control section
30 Data bus
31, 32 Memory
33 Hard disk drive (HDD)
34 Optical disk drive mechanism
35 Host device
111a, 111b Analog-to-digital converter (ADC)
112 Encoder
113 Decoder
114 Stream control portion
121 Servo control portion
122 Signal processing portion
123 Host control portion

### BEST MODE FOR CARRYING OUT THE INVENTION

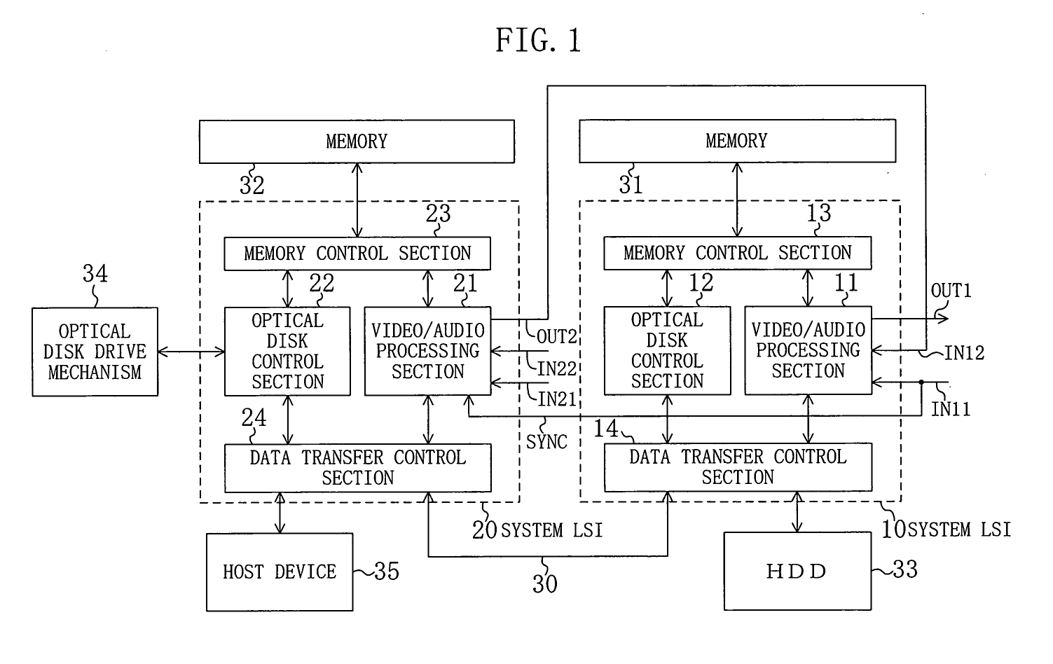

FIG. 1 shows an exemplary configuration of a video/audio recording/playback apparatus of the present invention. The video/audio recording/playback apparatus of FIG. 1 includes first and second system LSIs 10 and 20, first and second memories 31 and 32, a hard disk drive (HDD) 33, an optical disk drive mechanism 34 and a host device 35.

The first system LSI 10 includes a video/audio processing section 11, an optical disk control section 12, a memory control section 13 and a data transfer control section 14. The video/audio processing section 11 has two-route video/audio inputs IN11 and IN12 and one-route video/audio output OUT1, and is connected to the memory control section 13 and the data transfer control section 14. The optical disk control section 12 is also connected to the memory control section 13 and the data transfer control section 14. The memory control section 13 is connected to the first memory 31. The video/audio-processing section 11 and the optical disk control section 12 share the first memory 31 via the memory control section 13.

Likewise, the second system LSI 20 includes a video/audio processing section 21, an optical disk control section 22, a memory control section 23 and a data transfer control section 24. The video/audio processing section 21 has two-route video/audio inputs IN21 and IN22 and one-route video/audio output OUT2, and is connected to the memory control section 23 and the data transfer control section 24. The optical disk control section 22 is also connected to the memory control section 23 and the data transfer control section 24. The memory control section 23 is connected to the second memory 32. The video/audio processing section 21 and the optical disk control section 22 share the second memory 32 via the memory control section 23.

A synchronizing signal SYNC in the video/audio input IN11 of the first system. LSI 10 is supplied to the video/audio processing section 21 of the second system LSI 20, and the video/audio output OUT2 of the second system LSI 20 is supplied to the video/audio processing section 11 of the first system LSI 10 as the video/audio input IN12. Data transfer between the first system LSI 10 and the second system LSI 20 is executed via a data bus 30 provided between their data transfer control sections 14 and 24. The HDD 33 is connected to the data transfer control section 14 of the first system LSI 10, the optical disk drive mechanism 34 is connected to the optical disk control section 22 of the second system LSI 20, and the host device 35 is connected to the data transfer control section 24 of the second system LSI 20. An optical disk such as DVD-R and DVD-RW can be mounted in the optical disk drive mechanism 34. The host device 35 is a microcontroller, for example.

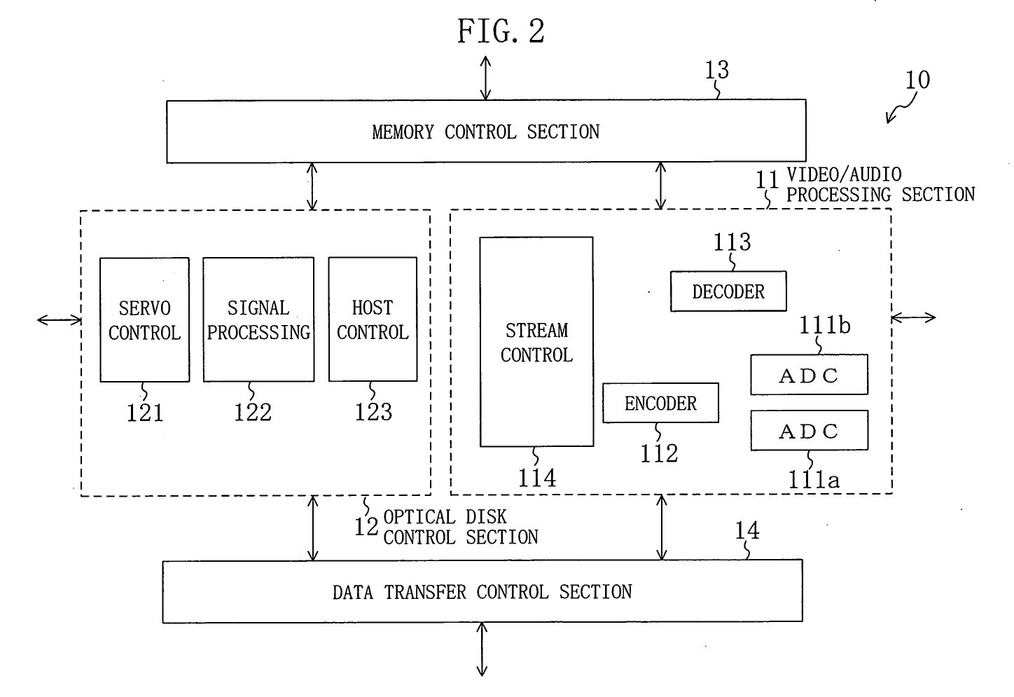

FIG. 2 shows internal detailed configurations of the video/audio processing section 11 and the optical disk control section 12 of the first system LSI 10. Since the second system LSI 20 is substantially the same in internal configuration as the first system LSI 10, only the first system LSI 10 will be described.

The video/audio processing section 11 includes first and second analog-to-digital converters (ADC) 111a and 111b, one encoder 112, one decoder 113 and a stream control portion 114. Each of the first and second ADCs 111a and 111b converts one-route video/audio input to digital information. The encoder 112 has a capability of compressing given two-route digital information in a time division manner. The decoder 113 decompresses compressed video/audio data. The stream control portion 114 performs stream control of processing added information given when compressed video/audio data is recorded in a hard disk or an optical disk, to generate stream data or extracts compressed video/audio data from stream data read from the hard disk or an optical disk.

The optical disk control section 12 includes a servo control portion 121, a signal processing portion 122 and a host control portion 123. The servo control portion 121 performs rotation control of an optical disk, travel control of an optical pickup, focus control of the optical pickup and the like. The signal processing portion 122 performs write/read signal processing for an optical disk and error correction. The host control portion 123 is responsible for data exchange of the signal processing portion 122 with the memory control section 13 and the data transfer control section 14.

In the video/audio recording/playback apparatus of FIG. 1, two-program simultaneous recording is achieved in the following manner. Assume herein that information of two channels given in parallel via two video/audio inputs IN11 and IN21 is recorded into the HDD 33. One video/audio input IN11, given to the first system LSI 10, is data-compressed with the video/audio processing section 11 and written into the HDD 33 via the data transfer control section 14. The other video/audio input IN21, given to the second system LSI 20, is data-compressed with the video/audio processing section 21, transmitted to the first system LSI 10 via the data transfer control section 24 and the data bus 30, and then written into the HDD 33 via the data transfer control section 14. In this way, the mutually connected first and second system LSIs 10 and 20 individually execute compression processing, to achieve two-program simultaneous recording. If three-program simultaneous recording is desired, a third system LSI may be connected via the data transfer control section 24 of the second system LSI 20. Likewise, fourth and fifth system LSIs may be connected.

In the video/audio recording/playback apparatus of FIG. 1, normal recording/playback operation can be executed even during dubbing from the hard disk to an optical disk.

The video/audio recording/playback apparatus of FIG. 1 has a capability of performing two-program continuous compression processing with only the video/audio processing section 21 of the second system LSI 20. The two-route video/audio inputs IN21 and IN22 of the second system LSI 20 are respectively converted to digital information with the ADCs 111a and 111b and then stored in respective input buffers in the second memory 32. The encoder 112 reads video/audio information units stored in the input buffers, compresses these information units by switching from one to the other every frame, generates respective stream data units with the stream control portion 114, and stores the generated stream data units in respective stream buffers in the second memory 32 via the memory control section 23. These stream data units are transmitted to the first system LSI 10 via the data transfer control section 24 and the data bus 30, and then written into the HDD 33 via the data transfer control section 14. In this way, also, two-program simultaneous recording is achieved.

Next, switching between real-time display and chasing playback display of a program under recording will be described. Assume in the following description that the video/audio input IN11 of the first system LSI 10 is to be recorded.

The video/audio input IN11 of the first system LSI 10 is data-compressed with the video/audio processing section 11 and written into the HDD 33 via the data transfer control section 14. For real-time display of this program under recording, the video/audio output OUT1 of the same video/audio processing section 11 is used.

While the first system LSI 10 is recording compressed video/audio data into the HDD 33 in the manner described above, the second system LSI 20 can read compressed video/audio data already recorded in the HDD 33 via the data transfer control section 14 for chasing playback display. The read compressed video/audio data is buffered in the second memory 32 so as to synchronize with the synchronizing signal SYNC in the video/audio input IN11, and then outputted, after being decompressed, as the video/audio output OUT2 of the second system LSI 20. The video/audio output OUT2 is supplied to the first system LSI 10 as the video/audio input IN12. The first system LSI 10 receives the video/audio input IN11 and also the video/audio input IN12 synchronizing with the video/audio input IN11. These inputs are switched therebetween to give the video/audio output OUT1.

As described above, the video/audio recording/playback apparatus of FIG. 1 can also easily achieve synchronization between real-time display and chasing playback display of a program during recording. Therefore, no disturbance occurs in the video/audio output OUT1 at the time of switching between the real-time display and the chasing playback display, ensuring seamless switching.

Alternatively, decompressed video/audio information in the second system LSI 20 may be buffered in the second memory 32 so as to synchronize with the synchronizing signal SYNC in the video/audio input IN11. Otherwise, the first system LSI 10 may buffer video/audio information obtained from the second system LSI 20 in the first memory 31 so as to synchronize with the synchronizing signal SYNC in the video/audio input IN11.

In the first and second system LSIs 10 and 20, independent testing can be made for the optical disk control section 12, 22 by stopping the operation of the video/audio processing section 11, 21. In reverse, independent testing can be made for the video/audio processing section 11, 21 by stopping the operation of the optical disk control section 12, 22.

### INDUSTRIAL APPLICABILITY

As described above, the video/audio recording/playback apparatus of the present invention has the effects that the number of programs that can be recorded simultaneously can be easily increased and also synchronization between real-time display and chasing playback display of a program under recording can be easily attained, and thus is useful as a recording/playback apparatus for broadcast programs.

1. A video/audio recording/playback apparatus permitting simultaneous recording of a plurality of programs, comprising:
a plurality of LSIs each having a function of performing compression processing for a video/audio input, a function of performing decompression processing for video/audio data, and a function of executing data transfer therebetween;
a disk drive connected to any of the plurality of LSIs; and
synchronization means for synchronizing a video/audio output of a second LSI among the plurality of LSIs with a video/audio input of a first LSI among the plurality of LSIs, the second LSI obtaining the video/audio output based on video/audio data already recorded in the disk drive while the first LSI being recording video/audio data obtained by performing compression processing for the video/audio input into the disk drive.

2. The video/audio recording/playback apparatus of claim 1,
wherein each of the plurality of LSIs comprises:
a video/audio processing section responsible for the compression processing and the decompressing processing; and
a data transfer control section responsible for the data transfer.

3. The video/audio recording/playback apparatus of claim 2,
wherein at least one of the plurality of LSIs further comprises an optical disk control section for controlling access to an optical disk drive mechanism.

4. The video/audio recording/playback apparatus of claim 2,
wherein each of the plurality of LSIs further comprises a memory control section for controlling access to a memory connected to the LSI.

5. The video/audio recording/playback apparatus of claim 4,
wherein the synchronization means permits the second LSI to buffer the video/audio data read from the disk drive in the memory connected to the second LSI so that the video/audio output of the second LSI is synchronized with the video/audio input of the first LSI.

6. The video/audio recording/playback apparatus of claim 4,
wherein the synchronization means permits the second LSI to buffer a video/audio output obtained by decompression processing in the memory connected to the second LSI so that the video/audio output of the second LSI is synchronized with the video/audio input of the first LSI.

7. The video/audio recording/playback apparatus of claim 4,
wherein the video/audio output of the second LSI is connected to the first LSI, and
the synchronization means permits the first LSI to buffer the video/audio output of the second LSI obtained by the first LSI in the memory connected to the first LSI so that the video/audio output of the second LSI is synchronized with the video/audio input of the first LSI.

8. The video/audio recording/playback apparatus of claim 1,
wherein at least one of the plurality of LSIs has a function of performing compression processing for two video/audio inputs in a time division manner.
